(19) United States
(12) Patent Application Publication
(10) Pub. No.: US 2024/0258000 A1
(43) Pub. Date: Aug. 1, 2024

(54) THERMALLY PROTECTED VARISTOR

(71) Applicant: XIAMEN SET ELECTRONICS CO., LTD., Xiamen (CN)

(72) Inventors: Yuecong TANG, Xiamen (CN); Xianggui ZHANG, Xiamen (CN); Yuxiang YUAN, Xiamen (CN); Jianguo JIANG, Xiamen (CN); Xiaolou WANG, Xiamen (CN)

(73) Assignee: XIAMEN SET ELECTRONICS CO., LTD., Xiamen (CN)

(21) Appl. No.: 18/290,305

(22) PCT Filed: Apr. 14, 2023
(86) PCT No.: PCT/CN2023/088427

§ 371 Date: Nov. 13, 2023

(30) Foreign Application Priority Data
Apr. 20, 2022 (CN) 202220910687.2

(51) Int. Cl. H01C 7/10; H01C 1/14

(52) U.S. Cl. CPC H01C 7/10; H01C 1/14

(57) ABSTRACT

A thermally protected varistor includes a frame, a varistor, a slider, an elastic member, and a reed electrode. The slider is provided between the reed electrode and the varistor. The reed electrode is welded to an electrode of the varistor through a low-melting-point alloy. The elastic member is connected to the slider to drive the slider to abut against a connection position between the reed electrode and the varistor. A wrapper made of a heat-resisting material is provided outside the slider. In the thermally protected varistor, the slider connected to the elastic member is provided between the varistor and the reed electrode to achieve automatic disconnection in case of overvoltage, thereby effectively protecting electrical equipment. The wrapper made of the heat-resisting material is provided on the slider, so as to prevent the slider from melting and catching fire due to a high current passing through.

### CROSS REFERENCE TO THE RELATED APPLICATIONS

The present disclosure claims priority to Chinese Patent Application 202220910687.2, filed with the China National Intellectual Property Administration (CNIPA) on Apr. 20, 2022, and titled “THERMALLY PROTECTED VARISTOR”, which is incorporated herein by reference in its entirety.

### TECHNICAL FIELD

The present disclosure relates to the technical field of surge protection circuits, and in particular to a thermally protected varistor.

### BACKGROUND

A thermally protected varistor is an overvoltage protection device used for electrical equipment. When the varistor encounters overvoltage, the low-melting-point alloy between the electrode of the varistor and the reed electrode melts due to being heated, such that the varistor is disconnected from the reed electrode to protect the electrical equipment. However, there is a problem with the existing thermally protected varistor on the market. When a lightning current of 50 A or above passes through the thermally protected varistor, the disconnecting device made of a material with a melting point of 100-350° C. usually cannot effectively break the arc. As a result, the material of the disconnecting device will melt and even catch fire to damage the electrical equipment, thereby threatening the safety of equipment and personnel.

### SUMMARY

To solve the problem occurring when the existing varistor is disconnected, wherein the material of the disconnecting device is prone to melt and even catch fire to damage the electrical equipment, the present disclosure provides a thermally protected varistor.

The thermally protected varistor includes a frame, a varistor, a slider, an elastic member, and a reed electrode, where the slider is provided between the reed electrode and the varistor; the reed electrode is welded to an electrode of the varistor through a low-melting-point alloy; the elastic member is connected to the slider to drive the slider to abut against a connection position between the reed electrode and the varistor; and a wrapper made of a heat-resisting material is provided outside the slider.

Further, a back side of the frame is provided with a mounting slot for accommodating the varistor, and a front side of the frame is provided with a storage slot for accommodating the reed electrode; the frame is provided with a through hole communicated with the storage slot through the mounting slot; the electrode of the varistor is welded to the reed electrode through the through hole; and the slider is slidably provided in the storage slot.

Further, the wrapper is a U-shaped shell sleeved on the slider.

Further, the wrapper is a ceramic layer.

Further, the frame is provided with a first remote signaling electrode and a second remote signaling electrode; and when the reed electrode is disconnected from the varistor, a connection state between the first remote signaling electrode and the second remote signaling electrode changes accordingly.

Further, the first remote signaling electrode and the second remote signaling electrode are abutted against a limit slot of the frame; and each of a side of the first remote signaling electrode abutted against the frame and a side of the second remote signaling electrode abutted against the frame is provided with a ventilation gap.

Further, the slider is provided with a compression part and a limit part; the frame is provided with an insertion slot; when the reed electrode is connected to the varistor, the limit part is inserted into the insertion slot, and the compression part compresses the first remote signaling electrode and the second remote signaling electrode, such that the first remote signaling electrode and the second remote signaling electrode are connected to form a normally closed remote signaling alarm; and when the reed electrode is disconnected from the varistor, the limit part is pulled out of the insertion slot, and the first remote signaling electrode and the second remote signaling electrode are rebounded and disconnected.

Further, the slider is provided with a compression part and a hook groove; when the reed electrode is connected to the varistor, the compression part compresses the first remote signaling electrode, and the second remote signaling electrode extends into the hook groove, such that the first remote signaling electrode and the second remote signaling electrode are disconnected to form a normally opened remote signaling alarm; and when the reed electrode is disconnected from the varistor, the compression part is disconnected from the first remote signaling electrode, and an inner wall of the hook groove moves the second remote signaling electrode to rebound, such that the first remote signaling electrode and the second remote signaling electrode are connected.

Further, the varistor is connected in series with a discharge tube.

Further, the back side of the frame is provided with the mounting slot for accommodating the varistor, an accommodation slot for accommodating the discharge tube, and a connection slot; and the electrode of the varistor and an electrode of the discharge tube extend into the connection slot and are connected to each other.

In the technical solution of the present disclosure, the slider connected to the elastic member is provided between the varistor and the reed electrode to achieve automatic disconnection in case of overvoltage, thereby effectively protecting electrical equipment. The wrapper made of the heat-resisting material is provided on the slider, so as to prevent the slider from melting and catching fire due to a high current passing through, thereby effectively protecting the safety of equipment and personnel.

The above description is merely a summary of the technical solutions of the present disclosure. In order to make the technical means of the present disclosure understood more clearly and implemented in accordance with the content of the specification, and in order to make the above and other objectives, features and advantages of the present disclosure more obvious and comprehensible, specific implementations of the present disclosure are described below.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description merely show some embodiments of the present disclosure, and those of ordinary skill in the art may still derive other drawings from these drawings without creative efforts.

FIG. 1 is an exploded view of a first thermally protected varistor according to an embodiment of the present disclosure;

FIG. 2 is an internal structural diagram of the thermally protected varistor, shown in FIG. 1, in a disconnected state;

FIG. 3 is a sectional view of the thermally protected varistor shown in FIG. 2;

FIG. 4 is an internal structural diagram of the thermally protected varistor, shown in FIG. 1, in a connected state;

FIG. 5 is a sectional view of the thermally protected varistor shown in FIG. 4;

FIG. 6 is a schematic diagram of a slider and a wrapper of the thermally protected varistor shown in FIG. 1;

FIG. 7 is a structural diagram of a first remote signaling electrode and a second remote signaling electrode of the thermally protected varistor shown in FIG. 1;

FIG. 8 is an internal structural diagram of a second thermally protected varistor according to an embodiment of the present disclosure;

FIG. 9 is an internal structural diagram of the thermally protected varistor, shown in FIG. 8, in a disconnected state;

FIG. 10 is a circuit diagram of a third thermally protected varistor according to an embodiment of the present disclosure;

FIG. 11 is a structural diagram of a back side of the third thermally protected varistor according to an embodiment of the present disclosure;

FIG. 12 is a circuit diagram of a fourth thermally protected varistor according to an embodiment of the present disclosure; and

FIG. 13 is a circuit diagram of a fifth thermally protected varistor according to an embodiment of the present disclosure.

### REFERENCE NUMERALS

1. frame; 11. mounting slot; 12. storage slot; 13. accommodation slot; 14. connection slot; 15. insertion slot; 2. varistor; 3. slider; 31. compression part; 32. limit part; 33. hook groove; 4. elastic member; 5. reed electrode; 51. low-melting-point alloy; 6. wrapper; 7. discharge tube; 81. first remote signaling electrode; 82. second remote signaling electrode; and 83. ventilation gap.

### DETAILED DESCRIPTION OF THE EMBODIMENTS

To make the above objectives, features and advantages of the present disclosure more comprehensible, the specific implementations of the present disclosure are clearly and completely described below with reference to the drawings. Obviously, the specific details described below are only part of the embodiments of the present disclosure, and the present disclosure may also be implemented in many other embodiments different from those herein. All other embodiments obtained by those of ordinary skill in the art based on the embodiments of the disclosure without creative efforts shall fall within the protection scope of the present disclosure.

It should be noted that, when a component is fixed to another component, the component may be fixed to the other component directly or via an intermediate component. When a component is connected to another component, the component may be connected to the another component directly or via an intermediate component. The terms “vertical”, “horizontal”, “left”, “right”, and similar terms used herein are just for illustrative purposes, and do not mean sole implementations.

Unless otherwise defined, all technical and scientific terms used in the specification have the same meaning as commonly understood by those skilled in the technical field of the present disclosure. The terms used in the specification of the present disclosure are merely for the purpose of describing specific embodiments, rather than to limit the present disclosure.

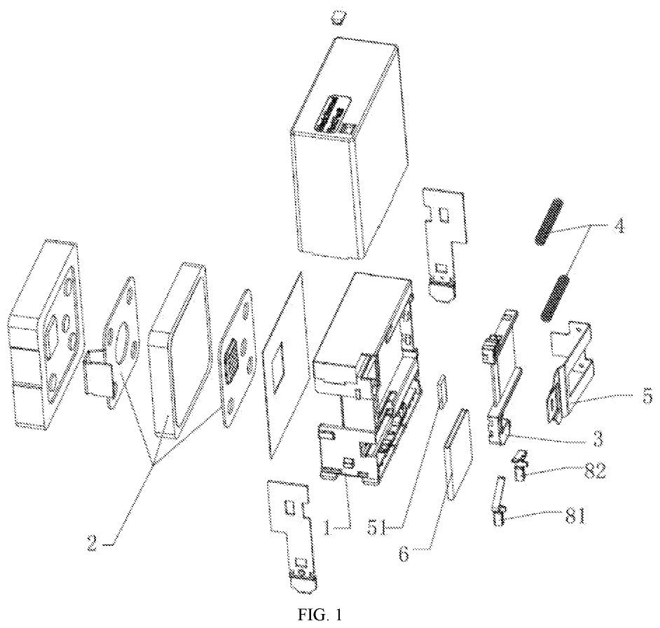

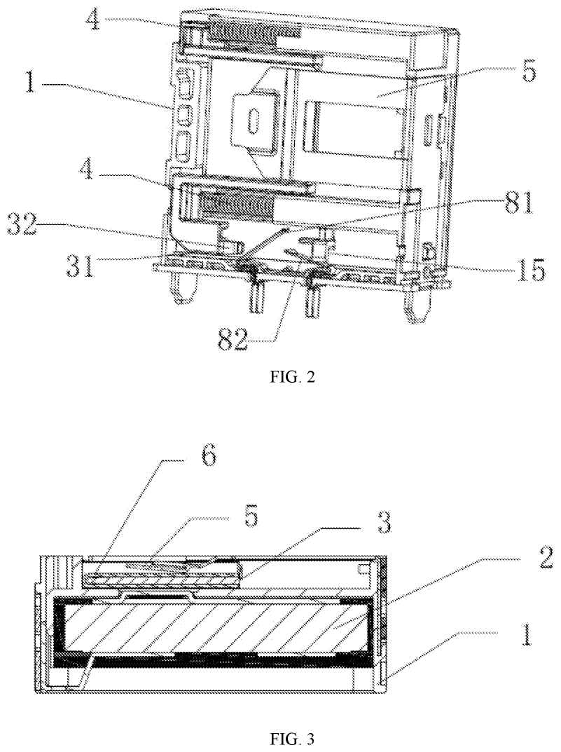

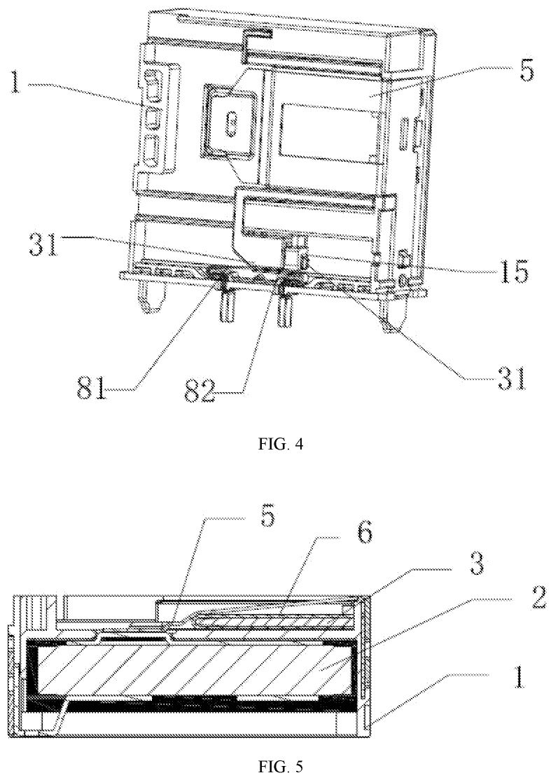

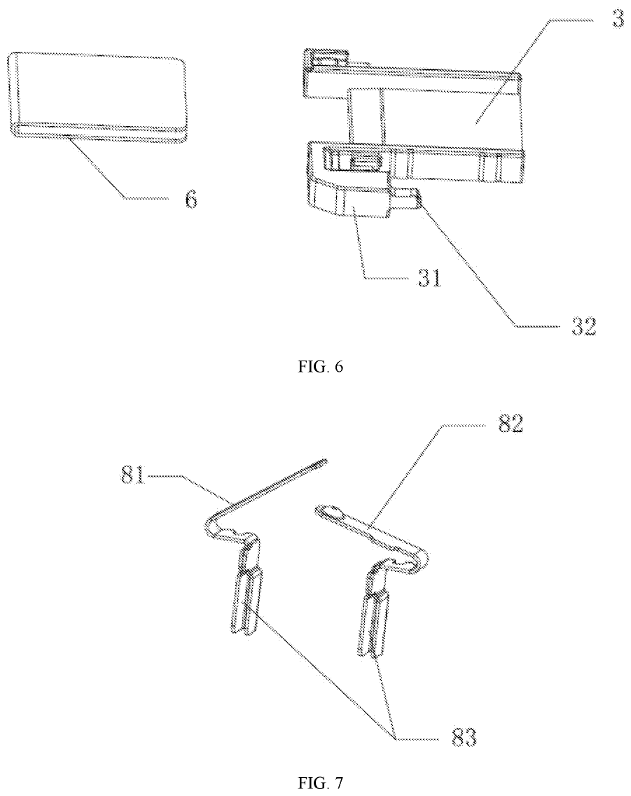

In a technical solution of the present disclosure, as shown in FIGS. 1 to 7, a thermally protected varistor includes frame 1, varistor 2, slider 3, elastic member 4, and reed electrode 5. The slider 3 is provided between the reed electrode 5 and the varistor 2. The reed electrode 5 is welded to an electrode of the varistor 2 through low-melting-point alloy 51. The elastic member 4 is connected to the slider 3 to drive the slider 3 to abut against a connection position between the reed electrode 5 and the varistor 2. Wrapper 6 made of a heat-resisting material is provided outside the slider 3.

In the technical solution of the present disclosure, the slider 3 connected to the elastic member 4 is provided between the varistor 2 and the reed electrode 5 to achieve automatic disconnection in case of overvoltage, thereby effectively protecting electrical equipment. The wrapper 6 made of the heat-resisting material is provided on the slider 3, so as to prevent the slider 3 from melting and catching fire due to a high current passing through, thereby effectively protecting the safety of equipment and personnel.

On the basis of this embodiment, a back side of the frame 1 is provided with mounting slot 11 for accommodating the varistor 2. A front side of the frame 1 is provided with storage slot 12 for accommodating the reed electrode 5. The frame 1 is provided with a through hole communicated with the storage slot 12 through the mounting slot 11. The electrode of the varistor 2 is welded to the reed electrode 5 through the through hole. The slider 3 is slidably provided in the storage slot 12.

The varistor 2 includes a primary electrode and a secondary electrode. The primary electrode and the secondary electrode are respectively provided at two sides of the varistor 2 and are connected to the varistor 2. An isolation element is provided between the varistor 2 and the mounting slot 11 of the frame 1 to avoid heat transfer to the mounting slot 11 of the frame 1 during a tripping process, thereby avoiding bulging or melting of the mounting slot 11 and avoiding tripping failure. The varistor 2 can further include a resin. The resin is filled in a gap between the varistor 2 and the frame 1 to further provide isolation protection.

On the basis of this embodiment, the wrapper 6 is a U-shaped shell sleeved on the slider 3. The U-shaped shell can be directly sleeved on the slider 3, providing high temperature resistance. Of course, the slider 3 can also be made of a heat-resisting material. Alternatively, the slider 3 can also be made of a common material and coated with fireproof slurry. The material of the slider is not limited by the description in this embodiment.

The melting point of the heat-resisting material is greater than 350° C., preferably between 1,083-5,000° C. Specifically, the wrapper 6 is a ceramic layer. Of course, it can also be other heat-resisting material that meets the above requirement for the melting point.

On the basis of this embodiment, the frame 1 is provided with first remote signaling electrode 81 and second remote signaling electrode 82. When the reed electrode 5 is disconnected from the varistor 2, a connection state between the first remote signaling electrode 81 and the second remote signaling electrode 82 changes accordingly. When the varistor 2 is disconnected from the reed electrode 5, a warning signal is issued through the remote signaling electrodes to prompt maintenance personnel.

In this embodiment, the first remote signaling electrode 81 and the second remote signaling electrode 82 are abutted against a limit slot of the frame 1. Each of a side of the first remote signaling electrode 81 abutted against the frame 1 and a side of the second remote signaling electrode 82 abutted against the frame 1 is provided with ventilation gap 83.

It should be noted that the ventilation gap 83 can be in an inverted-U shape or a hollow square shape. During a wave soldering process, it is easy to generate a heat wave when a tin flow spurts from bottom to top towards a welding area. The ventilation gap in the inverted-U shape or hollow square shape can quickly remove hot air from a slot in the inverted-U shape or hollow square shape to avoid an air hole or an inveracious solder thereby achieving a desired soldering effect.

In this embodiment, these two remote signaling electrodes are normally closed. The slider 3 is provided with compression part 31 and limit part 32. The frame 1 is provided with insertion slot 15. When the reed electrode 5 is connected to the varistor 2, the limit part 32 is inserted into the insertion slot 15, and the compression part 31 compresses the first remote signaling electrode 81 and the second remote signaling electrode 82, such that the first remote signaling electrode 81 is connected to the second remote signaling electrode 82. When the reed electrode 5 is disconnected from the varistor 2, the limit part 32 is pulled out of the insertion slot 15, and the first remote signaling electrode 81 and the second remote signaling electrode 82 are rebounded and disconnected.

It can be understood that the limit part 32 of the slider 3 penetrates into the insertion slot 15 of the frame 1, ensuring that an extrusion area of the slider 3 smoothly compresses the first remote signaling electrode 81 and the second remote signaling electrode 82 during preparation, transfer or in a long-term harsh condition, further providing a basic guarantee for avoiding intermittent false alarms in remote signaling.

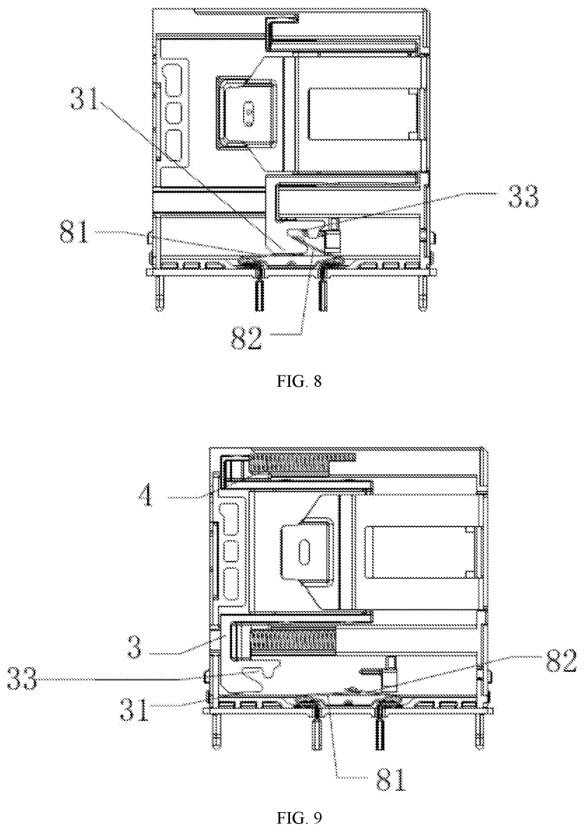

Referring to FIGS. 8 and 9, in some embodiments, the two remote signaling electrodes are normally open. The slider 3 is provided with compression part 31 and hook groove 33. When the reed electrode 5 is connected to the varistor 2, the compression part 31 compresses the first remote signaling electrode 81. The second remote signaling electrode 82 extends into the hook groove 33, and the first remote signaling electrode 81 is disconnected from the second remote signaling electrode 82. At this point, the first remote signaling electrode and the second remote signaling electrode are physically disconnected by the compression part 31 of the slider 3 and the hook groove. When the reed electrode 5 is disconnected from the varistor 2, the compression part 31 is disconnected from the first remote signaling electrode 81, and an inner wall of the hook groove 33 moves the second remote signaling electrode 82 to rebound. The first remote signaling electrode and the second remote signaling electrode elastically collide and come into contact, thereby emitting an alarm signal, and the first remote signaling electrode 81 is connected to the second remote signaling electrode 82.

In some embodiments of the present disclosure, the varistor 2 is connected in series with discharge tube 7. Specifically, the back side of the frame 1 is provided with the mounting slot 11 for accommodating the varistor 2, accommodation slot 13 for accommodating the discharge tube 7, and connection slot 14. The electrode of the varistor 2 and an electrode of the discharge tube 7 extend into the connection slot 14 and are connected to each other.

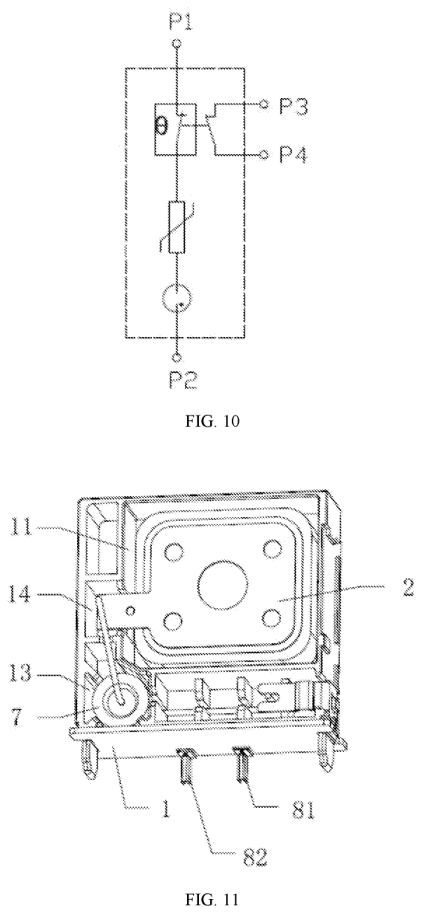

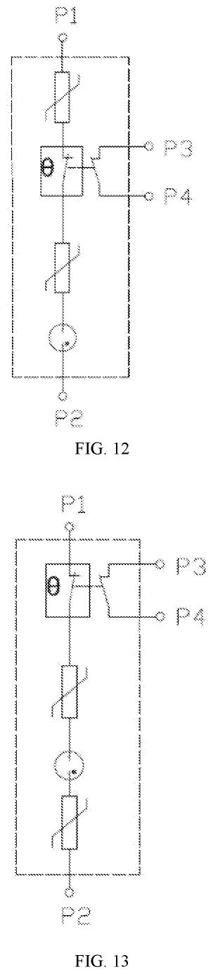

It can be understood that, referring to FIGS. 10 to 13, the discharge tube 7 and the varistor 2 can be connected in different series modes to meet higher photovoltaic system requirements, achieving low residual voltage and long service life.

In addition, in this embodiment, a device shell includes a state recognition transparent zone. The frame 1 and the slider 3 can be in different colors. In a working mode, the color of frame 1 can be observed through the state recognition transparent zone, and in a failure state, the color of the slider 3 can be observed, thereby achieving a state recognition function.

The thermally protected varistor proposed in this technical solution can effectively break an arc by selecting an effective material of the disconnecting device, and can ensure the reliability of the remote signaling alarm device and the soldering effect during the wave soldering process through the remote signaling structure.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

The above embodiments are only intended to illustrate several implementations of the present disclosure in detail, and they should not be construed as a limitation to the patentable scope of the present disclosure. It should be pointed out that those of ordinary skill in the art may further make several modifications, substitutions and improvements without departing from the concept of the present disclosure. However, such modifications, substitutions and improvements should be covered by the scope of protection of the present disclosure. Therefore, the protection scope of the present disclosure is subject to the claims.

What is claimed is:

1. A thermally protected varistor, comprising a frame, a varistor, a slider, an elastic member, and a reed electrode, wherein the slider is provided between the reed electrode and the varistor; the reed electrode is welded to an electrode of the varistor through a low-melting-point alloy; the elastic member is connected to the slider to drive the slider to abut against a connection position between the reed electrode and the varistor; and a wrapper made of a heat-resisting material is provided outside the slider.

2. The thermally protected varistor according to claim 1, wherein a back side of the frame is provided with a mounting slot for accommodating the varistor, and a front side of the frame is provided with a storage slot for accommodating the reed electrode; the frame is provided with a through hole communicated with the storage slot through the mounting slot; the electrode of the varistor is welded to the reed electrode through the through hole; and the slider is slidably provided in the storage slot.

3. The thermally protected varistor according to claim 1, wherein the wrapper is a U-shaped shell sleeved on the slider.

4. The thermally protected varistor according to claim 1, wherein the wrapper is a ceramic layer.

5. The thermally protected varistor according to claim 1, wherein the frame is provided with a first remote signaling electrode and a second remote signaling electrode; and when the reed electrode is disconnected from the varistor, a connection state between the first remote signaling electrode and the second remote signaling electrode changes accordingly.

6. The thermally protected varistor according to claim 5, wherein the first remote signaling electrode and the second remote signaling electrode are abutted against a limit slot of the frame; and each of a side of the first remote signaling electrode abutted against the frame and a side of the second remote signaling electrode abutted against the frame is provided with a ventilation gap.

7. The thermally protected varistor according to claim 5, wherein the slider is provided with a compression part and a limit part; and the frame is provided with an insertion slot; and
when the reed electrode is connected to the varistor, the limit part is inserted into the insertion slot, and the compression part compresses the first remote signaling electrode and the second remote signaling electrode, such that the first remote signaling electrode and the second remote signaling electrode are connected to form a normally closed remote signaling alarm; and when the reed electrode is disconnected from the varistor, the limit part is pulled out of the insertion slot, and the first remote signaling electrode and the second remote signaling electrode are rebounded and disconnected.

8. The thermally protected varistor according to claim 5, wherein the slider is provided with a compression part and a hook groove; and
when the reed electrode is connected to the varistor, the compression part compresses the first remote signaling electrode, and the second remote signaling electrode extends into the hook groove, such that the first remote signaling electrode and the second remote signaling electrode are disconnected to form a normally opened remote signaling alarm; and when the reed electrode is disconnected from the varistor, the compression part is disconnected from the first remote signaling electrode, and an inner wall of the hook groove moves the second remote signaling electrode to rebound, such that the first remote signaling electrode and the second remote signaling electrode are connected.

9. The thermally protected varistor according to claim 1, wherein the varistor is connected in series with a discharge tube.

10. The thermally protected varistor according to claim 9, wherein the back side of the frame is provided with a mounting slot for accommodating the varistor, an accommodation slot for accommodating the discharge tube, and a connection slot; and the electrode of the varistor and an electrode of the discharge tube extend into the connection slot and are connected to each other.

11. The thermally protected varistor according to claim 2, wherein the varistor is connected in series with a discharge tube.

12. The thermally protected varistor according to claim 11, wherein the back side of the frame is provided with the mounting slot for accommodating the varistor, an accommodation slot for accommodating the discharge tube, and a connection slot; and the electrode of the varistor and an electrode of the discharge tube extend into the connection slot and are connected to each other.
